(19) United States
(12) Patent Application Publication
(10) Pub. No.: US 2024/0057009 A1
(43) Pub. Date: Feb. 15, 2024

(54) INTER-NETWORK NODE DELAY DRIVEN HARQ FEEDBACK OFFSET DESIGN FOR INTER-NETWORK NODE CARRIER AGGREGATION

(71) Applicant: Telefonaktiebolaget LM Ericsson (publ), Stockholm (SE)

(72) Inventors: Ping YU, Ottawa (CA); Ramy ATAWIA, Kanata (CA)

(21) Appl. No.: 18/253,278

(22) PCT Filed: Nov. 11, 2021
(86) PCT No.: PCT/IB2021/060463

§ 371 Date: May 17, 2023

Related U.S. Application Data
(60) Provisional application No. 63/114,846, filed on Nov. 17, 2020.

(51) Int. Cl. H04W 56/00; H04L 1/1812

(52) U.S. Cl. CPC H04W 56/0065; H04L 1/1812

(57) ABSTRACT

A first network node configured to communicate with a second network node and a wireless device, WD, is described. The first network node includes processing circuitry configured to determine a link profile of a communication link between the first network node and the second network node and determine a set of time offset values. Each time offset value indicates a time delay between a downlink transmission from the second network node and a corresponding uplink transmission from the WD to the first network node. The set of time offset values are determined based at least in part on the link profile.

### TECHNICAL FIELD

The present disclosure relates to wireless communications, and in particular, to inter-network node delay driven hybrid automatic repeat request (HARQ) feedback offset design for inter-network node carrier aggregation.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

NR inter-network node carrier aggregation (CA) extends the coverage and capacity of 5G bands. For example, a special cell (SpCell), used as an NR primary cell for master or secondary groups, can be operating in the sub 6 spectrum (<6 GHz) and the secondary cell (SCell) can be operated in the mmWave spectrum (>20 GHz). Both the SpCell and SCell are complimentary; the SpCell can provide extended cell range (up to ˜0 Km) but with a limited bandwidth (BW) (10 MHz), while the SCell can provide limited coverage (˜0.2 Km due to limited uplink (UL) coverage) but with a larger spectrum (200 MHz).

Inter-network node CA allows the operator to serve a wireless device (WD) at extended SCell range (>0.2 Km) by leveraging the good uplink coverage of SpCell, where the WD uses the frequency spectrum of the SpCell to transmit the physical uplink shared channel (PUSCH) and physical uplink control channel (PUCCH). Typically, the time slot at which the PUCCH (carrying the SCell downlink HARQ feedback) is known in advance to the SpCell which decodes and forwards the HARQ report to the SCell over an inter-gNB link (hereafter referred to in the general sense as an inter-network node link). However, data exchange over such link may experience a long round-trip delay (e.g., 1 to 10 ms) due to non-collocated network nodes of SpCell and SCell, as illustrated in the example of FIG. 1. Due to the difference in their channel characteristics, the network node for the SpCell and the network node of the SCell may not be co-located at the same site. For instance, the SpCell network node can be placed on top of a building to provide extended coverage, while the SCell network node can be placed at a street level to provide peak throughput at hotspots. Such deployment may result in delayed signaling between the SpCell and the SCell (between 1 and 10 ms). This requires pre-alignment between the SCell and SpCell for PUCCH slots prior to data transmission to ensure proper decoding of WD feedback.

There are 2 types of HARQ-acknowledgement (ACK) codebooks defined by the 3GPP: dynamic codebook (type 2) and semi-static codebook (type 1). If a dynamic codebook is used, the network node, e.g., gNB, must know the exact HARQ-ACK bits that the WD is reporting via the uplink (UL) channel (PUCCH or PUSCH). The HARQ-ACK bits map to the total number of downlink (DL) transmissions to be acknowledged in the same UL slot. The time offset from DL data to UL HARQ-ACK feedback is known as K1.

K1 can be configured with up to 8 different values to a WD according 3GPP, which allows the network node to bundle DL transmissions from different time slots to be acknowledged at the same UL slot. As a principle, smaller K1s may be used for achieving minimal end to end (E2E) data transfer latency. If the inter-network node link between SpCell and SCell has a long round trip timing (RTT) delay, coordinating DL data transmissions via SpCell and SCell becomes difficult. Therefore, the SpCell may prearrange dedicated PUCCH resources and UL slot sets for the SCell scheduler to schedule DL data transmitted via the SCell. But, if a small K1 is applied on the SCell DL data transmission, the HARQ-ACK feedback from the WD may arrive at the SpCell before the SCell informs the SpCell of its scheduling status.

An example is illustrated in FIG. 2, where a short K1 value is selected which will result in HARQ feedback from WD to SpCell before the latter gets informed by SCell about the feedback PUCCH allocation (since inter-network node delay >K1). Thus, the SpCell will not be able to perform decoding of the HARQ feedback bits for all WDs sharing the same PRB resulting in degrading the total system throughput.

### SUMMARY

Some embodiments advantageously provide methods, systems, and apparatuses for inter-network node delay driven hybrid automatic repeat request (HARQ) feedback offset design for inter-network node carrier aggregation.

In some embodiments, one or more of the following steps may be performed:
1. The SpCell performs profiling for the inter-network node link between SpCell and SCell with applicable delay range;
2. The network node configures a set of K1s (up to 8 according to 3GPP) in PUCCH-config for the CA WD based on its capability and inter-network node link between its SpCell and SCell based on the profiling;
3. A proper K1 within the set is selected for SpCell HARQ-ACK feedbacks and SCell(s) corresponding to the applied delay range based on the profile. The selected K1 also satisfies DL data transmissions on SpCell and SCell:
   a) Available UL target at SpCell for carrying the HARQ-ACK feedback; and
   b) Apply smallest applicable K1 for fast HARQ-ACK responded by WD; and
4. The SpCell and the SCell monitor inter-network node delay and adjust K1s to be used for SCell HARQ-ACKs:
   a) SCell selects a proper K1 in DCI1_1 within the configured K1 set; or
   b) Reconfigure K1 sets if the inter-network node delay changes require a different profile.

Some advantages of some embodiments include:
1. Enabling NR inter-network node carrier aggregation between non-collocated SpCell and SCell; and
2. Robust decoding of HARQ feedback from CA WDs at the SpCell.

According to an aspect of the present disclosure, a first network node configured to communicate with a second network node and a wireless device, WD, is described. The first network node includes processing circuitry configured to determine a link profile of a communication link between the first network node and the second network node; and determine a set of time offset values. Each time offset value indicates a time delay between a downlink transmission from the second network node and a corresponding uplink transmission from the WD to the first network node. The set of time offset values are determined based at least in part on the link profile.

In some embodiments, each time offset value of the set of time offset values is a K1 value indicating the time delay between the downlink transmission and the corresponding uplink transmission.

In some other embodiments, the corresponding uplink transmission is a Hybrid Automatic Repeat Request, HARQ, feedback.

In an embodiment, the first network node operates on a first cell, the second network node operates on a second cell, and the WD operates on the first and second cells.

In another embodiment, the link profile includes a link time delay, a jitter, a packet loss, and a Round Trip Time, RTT, of a packet associated with the communication link between the first network node and the second network node.

In some embodiments, the processing circuitry is further configured to monitor the communication link and update the link profile based on the monitored communication link.

In some other embodiments, the set of time offset values includes at least one time offset value that is greater than a maximum delay plus a safety margin.

In an embodiment, the set of time offset values includes a smallest time offset value in the set that is greater than a minimal delay plus a safety margin.

In another embodiment, the first network node (16a) further includes a communication interface and a radio interface, and any one of the radio interface and the communication interface is configured to transmit the set of time offset values to the second network node.

In some embodiments, the radio interface is further configured to receive the corresponding uplink transmission from the WD and any one of the radio interface and the communication interface is further configured to transmit a report to the second network node, the report including at least the received corresponding uplink transmission from the WD.

According to another aspect, a method implemented in a first network node configured to communicate with a second network node and a wireless device, WD, is described. The method includes determining a link profile of a communication link between the first network node and the second network node; and determining a set of time offset values, each time offset value indicating a time delay between a downlink transmission from the second network node and a corresponding uplink transmission from the WD to the first network node. The set of time offset values being determined based at least in part on the link profile.

In some embodiments, each time offset value of the set of time offset values is a K1 value indicating the time delay between the downlink transmission and the corresponding uplink transmission.

In some other embodiments, the corresponding uplink transmission is a Hybrid Automatic Repeat Request, HARQ, feedback.

In an embodiment, the first network node operates on a first cell, the second network node operates on a second cell, and the WD operates on the first and second cells.

In another embodiment, the link profile includes a link time delay, a jitter, a packet loss, and a Round Trip Time, RTT, of a packet associated with the communication link between the first network node and the second network node.

In some embodiments, the method further includes monitoring the communication link and update the link profile based on the monitored communication link.

In some other embodiments, the set of time offset values includes at least one time offset value that is greater than a maximum delay plus a safety margin.

In an embodiment, the set of time offset values includes a smallest time offset value in the set that is greater than a minimal delay plus a safety margin.

In another embodiment, the method further includes transmitting the set of time offset values to the second network node.

In some embodiments, the method further includes receiving the corresponding uplink transmission from the WD and transmitting a report to the second network node, where the report includes at least the received corresponding uplink transmission from the WD.

According to an aspect, a second network node configured to communicate with a first network node and a wireless device, WD, is described. The second network node comprising processing circuitry configured to determine a subset of a set of time offset values. Each time offset value of the set of time offset values indicates a time delay between a downlink transmission from the second network node and a corresponding uplink transmission from the WD to the first network node. The set of time offset values are determined based at least in part on a link profile of a communication link between the first network node and the second network node. The determined subset includes a smallest time offset value in the set that is greater than a maximum delay plus a safety margin and includes time offset values above the smallest time offset value.

In some embodiments, each time offset value of the set of time offset values is a K1 value indicating the time delay between the downlink transmission and the corresponding uplink transmission.

In some other embodiments, the corresponding uplink transmission is a Hybrid Automatic Repeat Request, HARQ, feedback.

In an embodiment, in the first network node operates on a first cell, the second network node operates on a second cell, and the WD operates on the first and second cells.

In another embodiment, the link profile includes a link time delay, a jitter, a packet loss, and a Round Trip Time, RTT, of a packet associated with the communication link between the first network node and the second network node.

In some embodiments, the second network node further includes a communication interface and a radio interface. Any one of the radio interface and the communication interface is configured to receive from the first network node the set of time offset values to the second network node.

In some other embodiments, the radio interface is further configured to transmit to the WD any one of the determined subset of the set of time offset values and the downlink transmission.

In an embodiment, any one of the radio interface and the communication interface is configured to receive a report from the first network node, where the report includes at least the corresponding uplink transmission from the WD.

In another embodiment, the processing circuitry is further configured to determine another link time delay of the communication link between the first network node and the second network node, where determining the subset of the set of time offset values is further based on the other link time delay.

In some embodiments, the link profile is updated based on monitoring of the communication link.

According to another aspect, a method implemented in a second network node configured to communicate with a first network node and a wireless device, WD, is described. The method includes determining a subset of a set of time offset values. Each time offset value of the set of time offset values indicates a time delay between a downlink transmission from the second network node and a corresponding uplink transmission from the WD to the first network node. The set of time offset values are determined based at least in part on a link profile of a communication link between the first network node and the second network node. The determined subset includes a smallest time offset value in the set that is greater than a maximum delay plus a safety margin and includes time offset values above the smallest time offset value.

In some embodiments, each time offset value of the set of time offset values is a K1 value indicating the time delay between the downlink transmission and the corresponding uplink transmission.

In some other embodiments, the corresponding uplink transmission is a Hybrid Automatic Repeat Request, HARQ, feedback.

In an embodiment, in the first network node operates on a first cell, the second network node operates on a second cell, and the WD operates on the first and second cells.

In another embodiment, the link profile includes a link time delay, a jitter, a packet loss, and a Round Trip Time, RTT, of a packet associated with the communication link between the first network node and the second network node.

In some embodiments, the method includes receiving from the first network node the set of time offset values to the second network node.

In some other embodiments, the method further includes transmitting to the WD any one of the determined subset of the set of time offset values and the downlink transmission.

In an embodiment, the method further includes receiving a report from the first network node, where the report includes at least the corresponding uplink transmission from the WD.

In another embodiment, the method further includes determining another link time delay of the communication link between the first network node and the second network node, where determining the subset of the set of time offset values is further based on the other link time delay.

In some embodiments, the link profile is updated based on monitoring of the communication link.

According to an aspect, a wireless device, WD, configured to communicate with a first network node and a second network node is described. The WD includes processing circuitry configured to determine a time offset value of a subset of time offset values. The time offset value indicates a time delay between a downlink transmission from the second network node and a corresponding uplink transmission from the WD to the first network node. The subset of time offset values is part of a set of time offset values. The subset includes a smallest time offset value in the set that is greater than a maximum delay plus a safety margin and includes time offset values above the smallest time offset value.

In some embodiments, the set is determined based at least in part on a link profile of a communication link between the first network node and the second network node.

In some other embodiments, each time offset value of the set of time offset values is a K1 value indicating the time delay between the downlink transmission and the corresponding uplink transmission.

In an embodiment, the link profile includes a link time delay, a jitter, a packet loss, and a Round Trip Time, RTT, of a packet associated with the communication link between the first network node and the second network node.

In another embodiment, the link profile is updated based on monitoring of the communication link.

In some embodiments, the corresponding uplink transmission is a Hybrid Automatic Repeat Request, HARQ, feedback.

In some other embodiments, the first network node operates on a first cell, the second network node operates on a second cell, and the WD operates on the first and second cells.

In an embodiment, the WD comprises a radio interface configured to receive any one of the subset of the set of time offset values and the downlink transmission.

In another embodiment, the radio interface is further configured to transmit the corresponding uplink transmission to the first network node based at least in part on the determined time offset value.

In some embodiments, transmitting the corresponding uplink transmission to the first network node triggers the first network node to transmit a report to the second network node, the report including at least the corresponding uplink transmission from the WD.

According to another aspect, a method implemented in a wireless device, WD, configured to communicate with a first network node and a second network node is described. The method includes determining a time offset value of a subset of time offset values. The time offset value indicates a time delay between a downlink transmission from the second network node and a corresponding uplink transmission from the WD to the first network node. The subset of time offset values is part of a set of time offset values. The subset includes a smallest time offset value in the set that is greater than a maximum delay plus a safety margin and includes time offset values above the smallest time offset value.

In some embodiments, the set is determined based at least in part on a link profile of a communication link between the first network node and the second network node.

In some other embodiments, each time offset value of the set of time offset values is a K1 value indicating the time delay between the downlink transmission and the corresponding uplink transmission.

In an embodiment, the link profile includes a link time delay, a jitter, a packet loss, and a Round Trip Time, RTT, of a packet associated with the communication link between the first network node and the second network node.

In another embodiment, the link profile is updated based on monitoring of the communication link.

In some embodiments, the corresponding uplink transmission is a Hybrid Automatic Repeat Request, HARQ, feedback.

In some other embodiments, the first network node operates on a first cell, the second network node operates on a second cell, and the WD operates on the first and second cells.

In an embodiment, the method further includes receiving any one of the subset of the set of time offset values and the downlink transmission.

In another embodiment, the method further includes transmitting the corresponding uplink transmission to the first network node based at least in part on the determined time offset value.

In some embodiments, transmitting the corresponding uplink transmission to the first network node triggers the first network node to transmit a report to the second network node, the report including at least the corresponding uplink transmission from the WD.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an illustration of an example network node, e.g., gNB, operating on a low band (sub 6 spectrum) PCell and another network node, e.g., another gNB, operating on a high band (mmWave spectrum) SCell;

FIG. 2 is an illustration of example signal exchange between a WD, a PCell and an SCell;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node for inter-network node delay driven hybrid automatic repeat request (HARQ) feedback offset design for inter-network node carrier aggregation according to some embodiments of the present disclosure;

FIG. 10 is a flowchart of another example process in a network node for inter-network node delay driven hybrid automatic repeat request (HARQ) feedback offset design for inter-network node carrier aggregation according to some embodiments of the present disclosure;

FIG. 11 is a flowchart of another example process in a network node according to some embodiments of the present disclosure;

FIG. 12 is a flowchart of another example in another network node according to some embodiments of the present disclosure;

FIG. 13 is a flowchart of another example in a WD according to some embodiments of the present disclosure;

FIG. 14 is a flowchart of an example process for link monitoring and K1 set selection performed by two cooperating network nodes according to some embodiments of the present disclosure; and

FIG. 15 is a signal diagram of some embodiments showing interactions between an SpCell, SCell and WD according to some embodiments of the present disclosure.

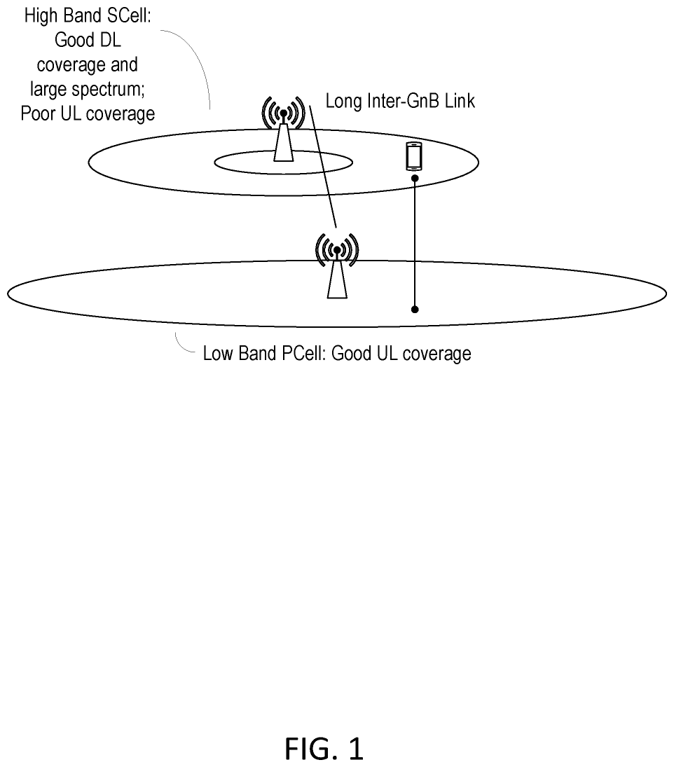

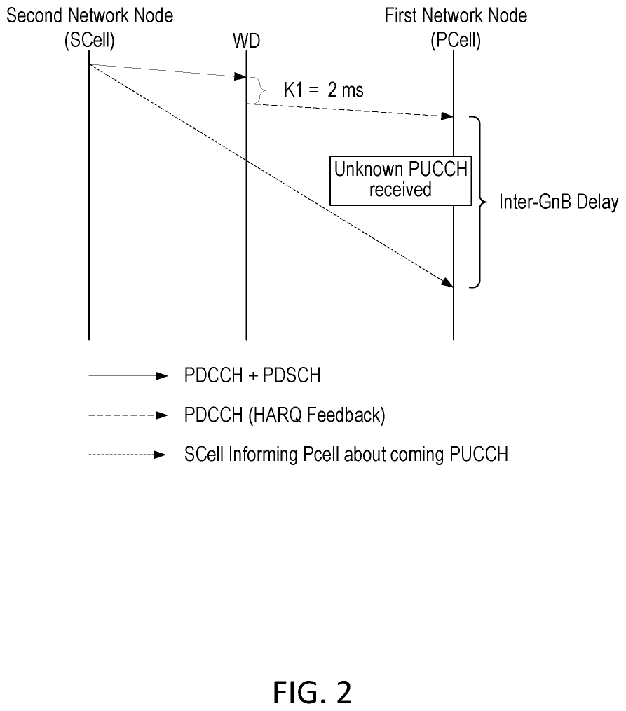

### DETAILED DESCRIPTION

Before describing in detail exemplary embodiments, it is noted that the embodiments reside primarily in combinations of apparatus components and processing steps related to inter-network node delay driven hybrid automatic repeat request (HARQ) feedback offset design for inter-network node carrier aggregation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node. The network node may be configured to operate in and/or be/establish any kind of cell. A cell may include any cell such as a PCell, an SCell, an SpCell, etc.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide inter-network node delay driven hybrid automatic repeat request (HARQ) feedback offset design for inter-network node carrier aggregation. As used herein, the term inter-network node link may be considered to include an inter-gNB link.

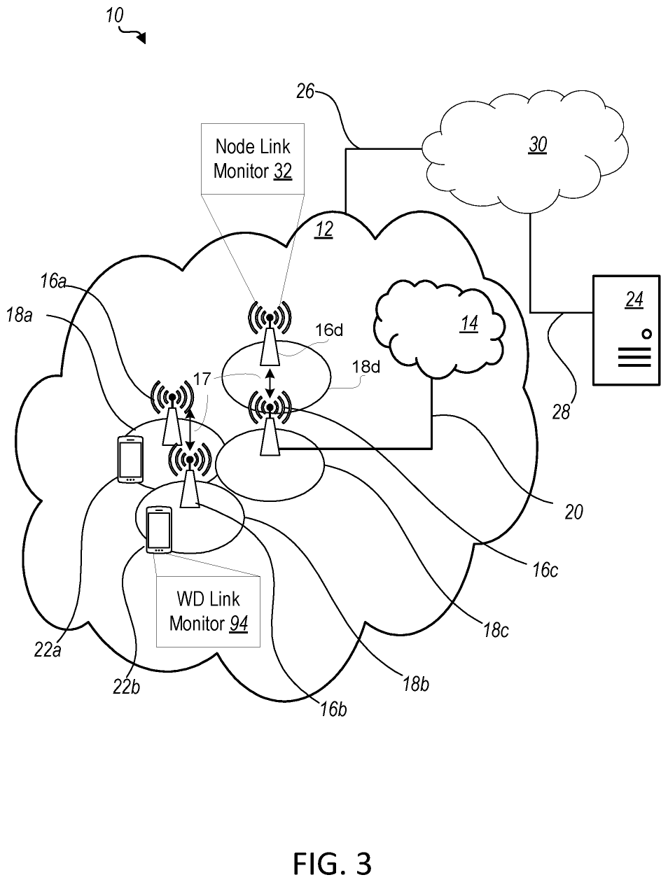

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c, 16d (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c, 16d is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network nodes 16. Note that although only two WDs 22 and three network nodes 16 are shown for convenience, the communication system may include many more WDs 22 and network nodes 16. Note that network nodes 16 may be collocated or separated by small or large distances. For example, network nodes 16a, 16b and 16c may be separated by large distances, whereas network nodes 16c and 16d may be collocated or separated by a relatively small distance. Also note that any two or more of the coverage areas 18a, 18b, 18c and 18d may overlap in whole, or in part, or not at all.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN. In some non-standalone (NSA) configurations, the WD 22 may be connected to the LTE network and to the NR SpCell using dual connectivity while being connected to the NR SpCell and the NR SCell using carrier aggregation. In some the standalone configuration embodiments, the WD 22 may be connected to the NR SpCell and the NR SCell.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 may be configured to include a node link monitor 32 which is configured to determine a link profile of a link between the first network node and a second network node operating on a second cell.

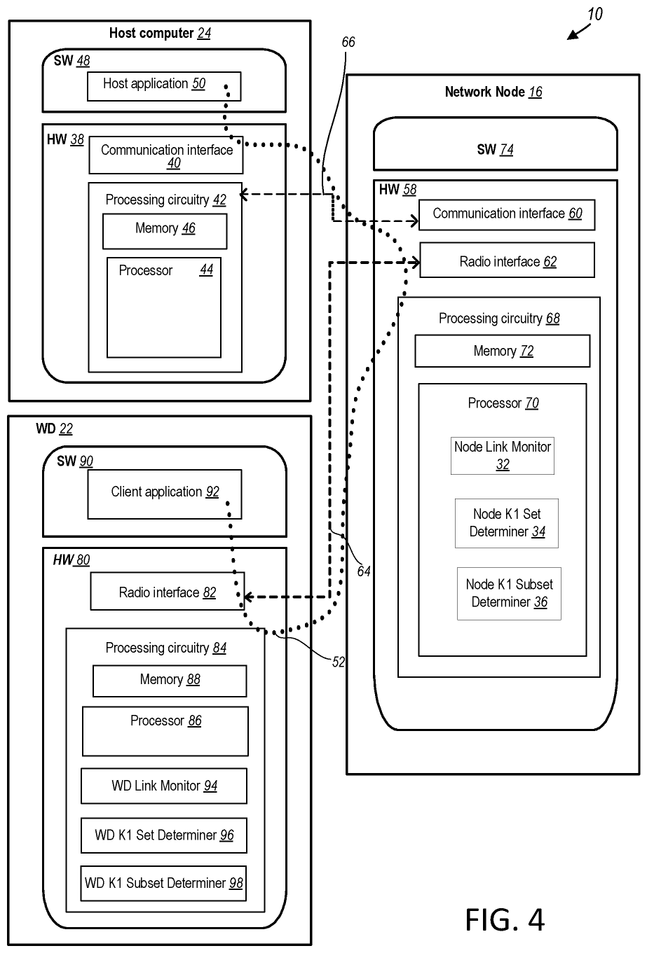

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network nodes 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a node link monitoring 32 which is configured to determine a link profile of a link between the first network node and a second network node operating on a second cell. The network node 16 may include a node K1 set determiner 34 configured to determine a set of K1 values, each K1 value indicating a delay between a downlink transmission and a corresponding hybrid automatic repeat request (HARQ) feedback on the second cell, the set of K1 values being determined based at least in part on the link profile. In some embodiments, the network node 16 may include a node K1 subset determiner 36 configured to determine a subset of the set of K1 values, the subset having a smallest K1 value in the set that is greater than a minimal delay plus a safety margin and having K1 values above the smallest K1 value. Note that in some embodiments, a first network node 16a, 16c and a second network node 16b, 16d may be collocated or closely located and connected by an inter network node communication link 17, as shown in FIG. 3. Inter network node communication link 17 may be monitored by any of the network nodes, e.g., 16a, 16b, 16c, and/or 16d via a node link monitor 32. Network node 16a, 16c may, for example, operate on a first cell (which may be the SpCell) and have the node K1 set determiner 34, whereas the network node 16b, 16d may, for example, operate on a second cell (which may be the SCell) and have the node K1 subset determiner 36. Although inter network node communication link 17 has been shown with respect to network nodes 16a, 16c and network node 16b, 16d, any network node 16 may be collocated and/or closely located and/or communicate with another network node such as via inter network node communication link 17.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. A network node 16 may be configured to include a WD link monitor unit 94 which is configured to perform any process/steps described herein, e.g., a process associated with determining a link profile of a link between the first network node and a second network node operating on a second cell.

In some embodiments, WD 22 may include a WD K1 set determiner 96 configured to perform any process/steps described herein, e.g., a process associated with determining a set of K1 values, each K1 value indicating a delay between a downlink transmission and a corresponding hybrid automatic repeat request (HARQ) feedback on a second cell, the set of K1 values being determined based at least in part on the link profile. In some other embodiments, the WD 22 may include a WD K1 subset determiner 98 configured to perform any process/steps described herein, e.g., a process associated with determining a subset of the set of K1 values, the subset having a smallest K1 value in the set that is greater than a minimal delay plus a safety margin and having K1 values above the smallest K1 value.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as node link monitor 32, node K1 set determiner 34 and node K1 subset determiner 36 as being within a respective processor, it is contemplated that these units may be implemented such that a portion of the unit is stored in a corresponding memory within the processing circuitry. Similarly, it is contemplated that node link monitor 32, node K1 set determiner 34 and node K1 subset determiner 36 may be implemented such that a portion of the unit is implemented using a corresponding memory within the processing circuitry. In other words, the units may be implemented in hardware or in a combination of hardware and software within the processing circuitry.

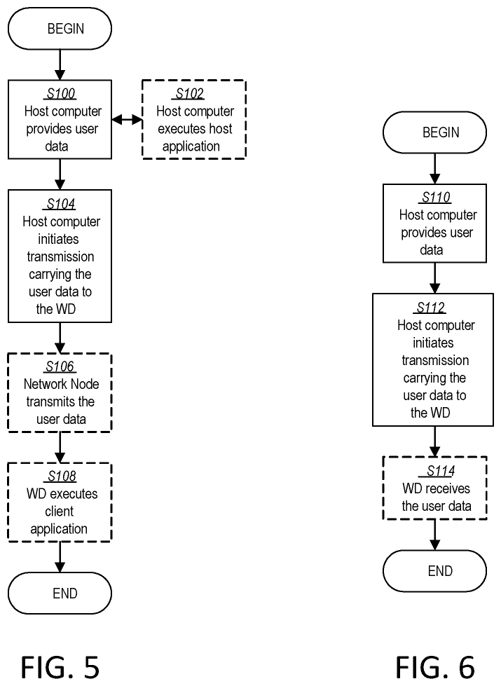

FIG. 5 is a flowchart illustrating an exemplary method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

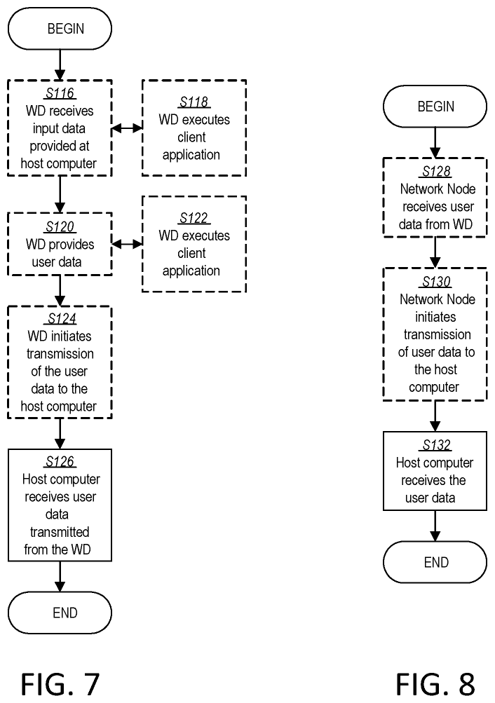

FIG. 7 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

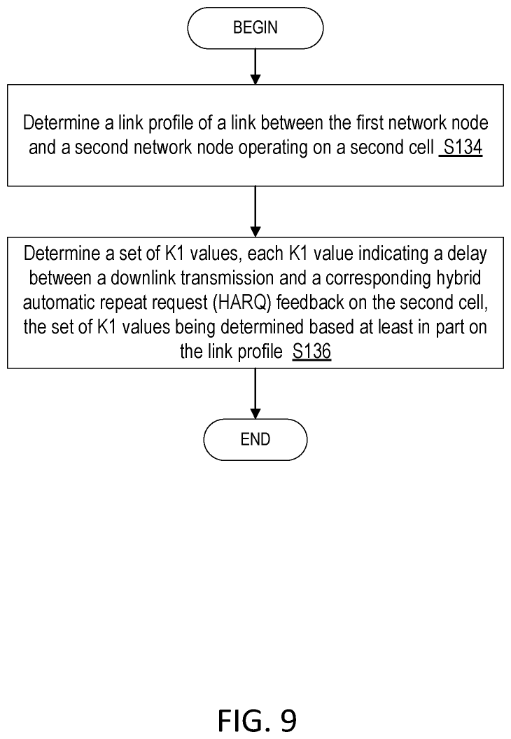

FIG. 9 is a flowchart of an example process in a network node 16 for inter-network node delay driven hybrid automatic repeat request (HARQ) feedback offset design for inter-network node carrier aggregation. The process of FIG. 9 may be performed in a network node 16 operating on an SpCell, for example. One or more blocks described herein may be performed by one or more elements of network node 16 such as by one or more of processing circuitry 68 (e.g., including the node link monitor 32 and node K1 set determiner 34), processor 70, radio interface 62 and/or communication interface 60. Network node 16 such as via processing circuitry 68 and/or processor 70 and/or radio interface 62 and/or communication interface 60 is configured to determine a link profile of a link between the first network node and a second network node operating on a second cell (Block S134). The process also includes determining a set of K1 values, each K1 value indicating a delay between a downlink transmission and a corresponding hybrid automatic repeat request (HARQ) feedback on the second cell, the set of K1 values being determined based at least in part on the link profile (Block S136).

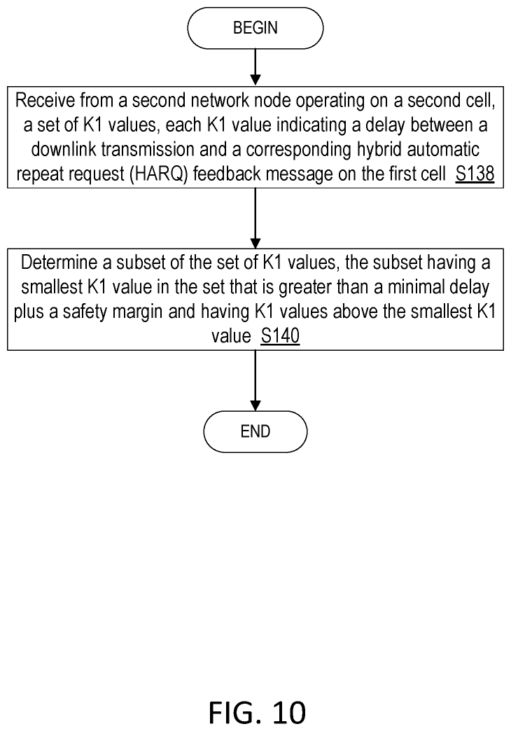

FIG. 10 is a flowchart of another example process in a network node 16 for inter-network node delay driven hybrid automatic repeat request (HARQ) feedback offset design for inter-network node carrier aggregation. The process of FIG. 10 may be performed in a network node 16 operating on an SCell, for example. One or more blocks described herein may be performed by one or more elements of network node 16 such as by one or more of processing circuitry 68 (including the node link monitor 32 and node K1 subset determiner 36), processor 70, radio interface 62 and/or communication interface 60. Network node 16 such as via processing circuitry 68 and/or processor 70 and/or radio interface 62 and/or communication interface 60 is configured to receive from a second network node operating on a second cell, a set of K1 values, each K1 value indicating a delay between a downlink transmission and a corresponding hybrid automatic repeat request (HARQ) feedback message on the first cell (Block S138). The process also includes determining a subset of the set of K1 values, the subset having a smallest K1 value in the set that is greater than a minimal delay plus a safety margin and having K1 values above the smallest K1 value (Block S140).

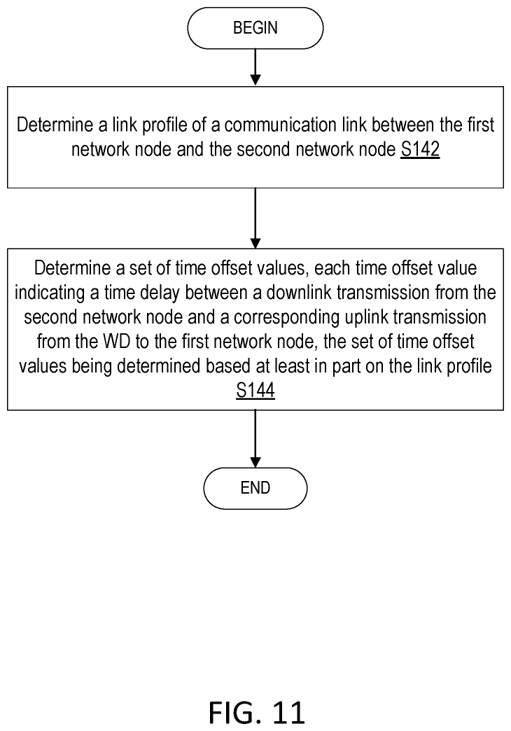

FIG. 11 shows a flowchart of another example process in a network node 16, e.g., a first network node 16a. One or more blocks described herein may be performed by one or more elements of network node 16 such as by one or more of processing circuitry 68 (including the node link monitor 32 and/or node K1 set determiner 34 and/or node K1 subset determiner 36), processor 70, radio interface 62 and/or communication interface 60. Network node 16, such as via processing circuitry 68 and/or processor 70 and/or radio interface 62 and/or communication interface 60. is configured to determine a link profile of a communication link between the first network node (16a) and the second network node (16b) (Block S142) and determine a set of time offset values, each time offset value indicating a time delay between a downlink transmission from the second network node (16b) and a corresponding uplink transmission from the WD (22) to the first network node (16a), the set of time offset values being determined based at least in part on the link profile (Block S144).

In some embodiments, each time offset value of the set of time offset values is a K1 value indicating the time delay between the downlink transmission and the corresponding uplink transmission.

In some other embodiments, the corresponding uplink transmission is a Hybrid Automatic Repeat Request, HARQ, feedback.

In an embodiment, the first network node operates on a first cell, the second network node (16b) operates on a second cell, and the WD (22) operates on the first and second cells.

In another embodiment, the link profile includes a link time delay, a jitter, a packet loss, and a Round Trip Time, RTT, of a packet associated with the communication link between the first network node (16a) and the second network node (16b).

In some embodiments, the processing circuitry (68) is further configured to monitor the communication link and update the link profile based on the monitored communication link.

In some other embodiments, the set of time offset values includes at least one time offset value that is greater than a maximum delay plus a safety margin.

In an embodiment, the set of time offset values includes a smallest time offset value in the set that is greater than a minimal delay plus a safety margin.

In another embodiment, the first network node (16a) further includes a communication interface (60) and a radio interface (62), and any one of the radio interface (62) and the communication interface (60) is configured to transmit the set of time offset values to the second network node (16b).

In some embodiments, the radio interface (62) is further configured to receive the corresponding uplink transmission from the WD (22) and any one of the radio interface (62) and the communication interface (60) is further configured to transmit a report to the second network node (16b), the report including at least the received corresponding uplink transmission from the WD (22).

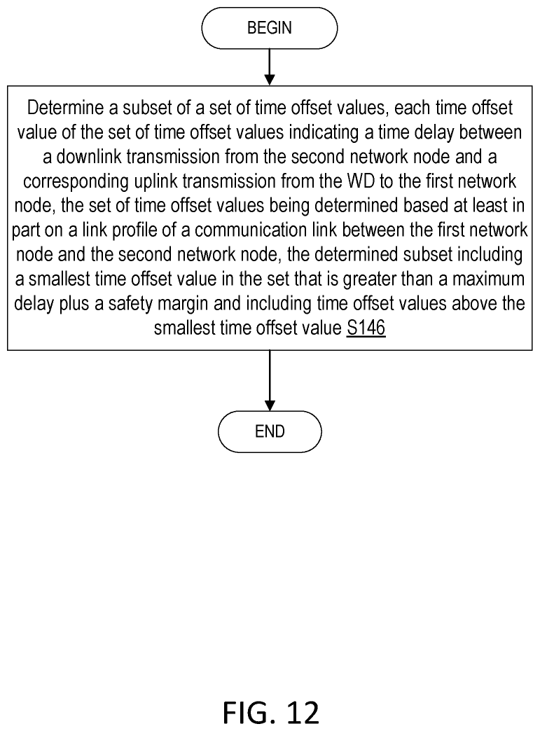

FIG. 12 shows a flowchart of another example process in a network node 16, e.g., a second network node 16b. One or more blocks described herein may be performed by one or more elements of network node 16 such as by one or more of processing circuitry 68 (including the node link monitor 32 and/or node K1 set determiner 34 and/or node K1 subset determiner 36), processor 70, radio interface 62 and/or communication interface 60. Network node 16, such as via processing circuitry 68 and/or processor 70 and/or radio interface 62 and/or communication interface 60, is configured to determine a subset of a set of time offset values (Block S146). Each time offset value of the set of time offset values indicates a time delay between a downlink transmission from the second network node (16b) and a corresponding uplink transmission from the WD (22) to the first network node (16a). The set of time offset values are determined based at least in part on a link profile of a communication link between the first network node (16a) and the second network node (16b). The determined subset includes a smallest time offset value in the set that is greater than a maximum delay plus a safety margin and includes time offset values above the smallest time offset value.

In some embodiments, each time offset value of the set of time offset values is a K1 value indicating the time delay between the downlink transmission and the corresponding uplink transmission.

In some other embodiments, the corresponding uplink transmission is a Hybrid Automatic Repeat Request, HARQ, feedback.

In an embodiment, in the first network node (16a) operates on a first cell, the second network node (16b) operates on a second cell, and the WD (22) operates on the first and second cells.

In another embodiment, the link profile includes a link time delay, a jitter, a packet loss, and a Round Trip Time, RTT, of a packet associated with the communication link between the first network node (16a) and the second network node (16b).

In some embodiments, the second network node (16b) further includes a communication interface (60) and a radio interface (62). Any one of the radio interface (62) and the communication interface (60) is configured to receive from the first network node (16a) the set of time offset values to the second network node (16b).

In some other embodiments, the radio interface (62) is further configured to transmit to the WD (22) any one of the determined subset of the set of time offset values and the downlink transmission.

In an embodiment, any one of the radio interface (62) and the communication interface (60) is configured to receive a report from the first network node (16a), where the report includes at least the corresponding uplink transmission from the WD (22).

In another embodiment, the processing circuitry (68) is further configured to determine another link time delay of the communication link between the first network node (16a) and the second network node (16b), where determining the subset of the set of time offset values is further based on the other link time delay.

In some embodiments, the link profile is updated based on monitoring of the communication link.

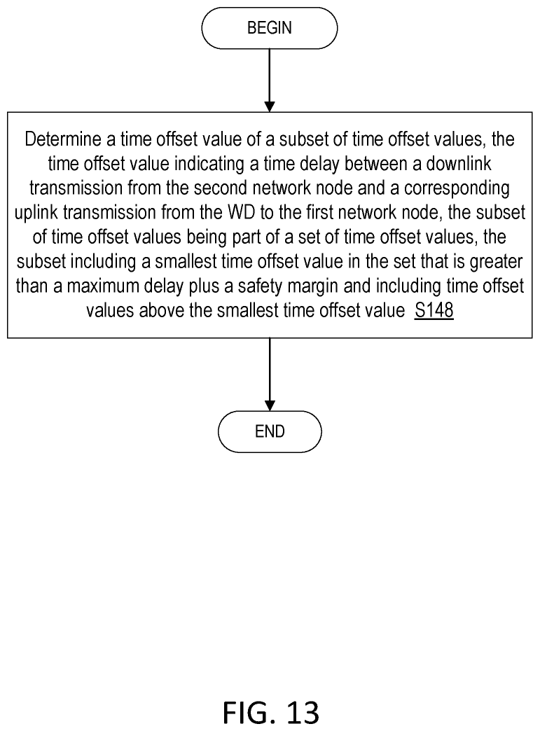

FIG. 13 shows a flowchart of another example process in a WD 22. One or more blocks described herein may be performed by one or more elements of WD 22 such as by one or more of processing circuitry 84 (including the WD link monitor unit 94 and/or WD K1 set determiner 96 and/or WD K1 subset determiner 98), processor 86, and/or radio interface 82. WD 22, such as via processing circuitry 84 and/or processor 86 and/or radio interface 82, is configured to determine a time offset value of a subset of time offset values (Block S148). The time offset value indicates a time delay between a downlink transmission from the second network node (16b) and a corresponding uplink transmission from the WD (22) to the first network node (16a). The subset of time offset values is part of a set of time offset values. The subset includes a smallest time offset value in the set that is greater than a maximum delay plus a safety margin and includes time offset values above the smallest time offset value.

In some embodiments, the set is determined based at least in part on a link profile of a communication link between the first network node (16a) and the second network node (16b).

In some other embodiments, each time offset value of the set of time offset values is a K1 value indicating the time delay between the downlink transmission and the corresponding uplink transmission.

In an embodiment, the link profile includes a link time delay, a jitter, a packet loss, and a Round Trip Time, RTT, of a packet associated with the communication link between the first network node (16a) and the second network node (16b).

In another embodiment, the link profile is updated based on monitoring of the communication link.

In some embodiments, the corresponding uplink transmission is a Hybrid Automatic Repeat Request, HARQ, feedback.

In some other embodiments, the first network node (16a) operates on a first cell, the second network node (16b) operates on a second cell, and the WD (22) operates on the first and second cells.

In an embodiment, the WD (22) comprises a radio interface (82) configured to receive any one of the subset of the set of time offset values and the downlink transmission.

In another embodiment, the radio interface (82) is further configured to transmit the corresponding uplink transmission to the first network node (16a) based at least in part on the determined time offset value.

In some embodiments, transmitting the corresponding uplink transmission to the first network node (16a) triggers the first network node (16a) to transmit a report to the second network node (16b), the report including at least the corresponding uplink transmission from the WD (22).

Having described the general process flow of arrangements of the disclosure and having provided examples of hardware and software arrangements for implementing the processes and functions of the disclosure, the sections below provide details and examples of arrangements for inter-network node delay driven hybrid automatic repeat request (HARQ) feedback offset design for inter-network node carrier aggregation.

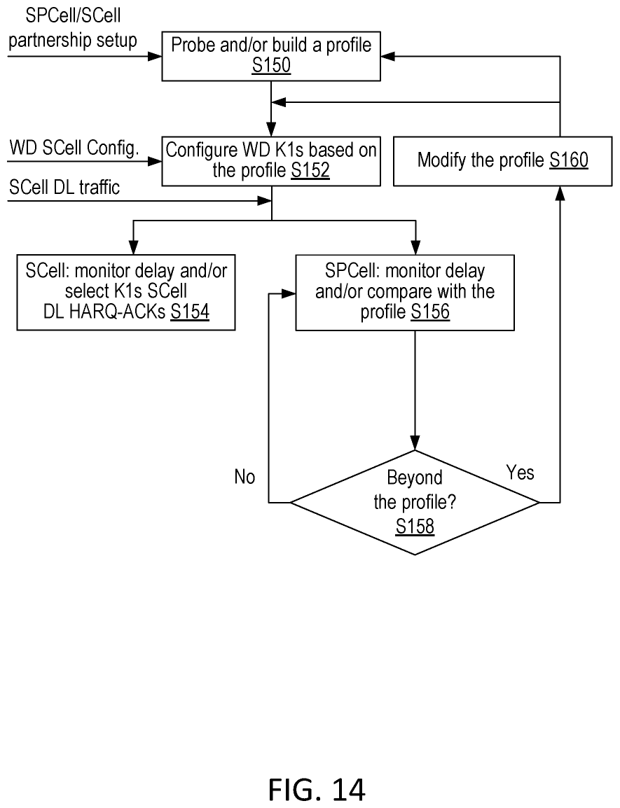

In some embodiments, a method may include (and/or a network node 16 and/or WD 22 may be configured to perform) the following steps/processes/features, e.g., as depicted in FIG. 14. For ease of understanding, it is noted that references to SCell and SpCell taking some action may refer to a network node 16 associated with that cell taking the action, e.g., a first network node 16a, a second network node 16b. Further, a link profile such as a profile associated with a inter network node communication link 17 between at least two network nodes (e.g., a first network node (16a) and the second network node (16b)) may refer to a gnB link profile, a link profile associated at least with a cell (e.g., SpCell, SCell, PCell, etc.), delay profile, inter-network node link profile, network node inter-link delay profile, delay range profile, and/or any profile. In some embodiments, SpCell may refer to a first network node 16a, and SCell may refer to a second network node 16b or vice versa but are not limited as such.

At step S150, probes requests may be transmitted and/or a profile (i.e., a link profile) may be determined. Step 150 may be performed during and/or be based at least in part on cell partnership setup, e.g., SpCell/SCell partnership setup. At step S152, WD K1s may be configured based on the profile (i.e., the link profile). Step 152 may be performed during and/or based at least in part on WD SCell configuration. At step S152, a network node 16, e.g., SCell, may monitor delay and/or select K1s, e.g., associated with SCell DL HARQ ACK. At step S156, another network node 16, e.g., SpCell may monitor delay and/or compare with the profile. Each one of steps S154 and S156 may be based at least in part on traffic information, e.g., SCell DL traffic. At step S158, if the monitored delay is beyond the parameters of the profile (e.g., beyond the profile), the profile may be modified, at step 160. Otherwise, the delay is monitored and/or compared as in step S156. The modified profile of step S160 may be used as an input to step S150 and/or as an input to step S152.

The following provide additional details associated with the processes shown with FIG. 14.

The SpCell profiles inter-network node link delays, e.g., during partnership setup (e.g., at step S150):
This step may be conducted at any cell partnership added to the SpCell network node, e.g., network node 16, and the network node RTT is measured;
The SpCell estimates some parameters of this link such as delay, jitter and packet loss rate;
Probe requests (SpCell to SCell to SpCell) may be transmitted, and the inter link round-trip time (RTT) measured; and
Jitter can be used, e.g., by repeating the probe requests at different times of the day such as to capture the variations in delay due to system load.

Inter-network node link delays adjustment, e.g., at runtime by SCell traffic activities:
Communications between SpCell and SCell may be established/maintained, e.g., so the inter-network node link delays can be monitored by both SpCell and SCell;
In the SCell: a K1 for WD HARQ-ACK feedback may be selected within the configured K1 set;
In the SpCell: the current inter-link delay may be compared with the delay profile, e.g., a link profile, for estimate whether reconfiguration is needed; and
The SpCell checks the inter-network node link profiles to determine the RTT. Selecting K1 value:
A minimum K1 value used for the SCell may be determined based on link delay (e.g., RTT/2); and
Based on numerologies applied on the SpCell and the SCell, the set of up to a predetermined amount of K1 values, e.g., 8 K1 values, may be determined and/or configured for the WD 22. The SpCell and SCell may have different subsets of K1s, e.g., for balancing the best RTT performances respectively. Communicate K1 value to WD:
A K1 set may be communicated to WD 22, e.g., as part of the SpCell PUCCH configuration; and
K1 value selection may be informed (i.e., transmitted) by using downlink control information (DCI), e.g., in each downlink control message.

### Embodiment 1: Online Learning for K1 Set Configuration

In this embodiment, a network node inter-link delay profile is built based at least in part on the SpCell and the SCell inter-link delay measurement results (e.g., link delay between two network nodes 16) and may initially be from an upper layer, with a specified delay range between the two network nodes.

The SpCell determines a set of K1 values (e.g., up to 8) that can meet at least one the following restrictions:
Candidate value selection of K1s for the SCell DL data transmissions may depend on the network node inter-link delay ranges provided by the link profile (may be referred to as “delay”), while pursuing minimal HARQ-ACK feedback delay;
K1 sets including (e.g., must include) at least one K1>(max delay+safety margin);
Minimal K1>(minimal delay+safety margin); and/or
Additional K1s for various delay situations and/or possible HARQ-ACK bits bundling.

For K1s for the SpCell DL data transmissions, selection of candidate may be made to achieve a predetermined (e.g., minimal) HARQ-ACK feedback delay and/or to reuse of the values selected for the SCell, e.g., in case K1 set size becomes an issue. For example, size may become an issue due to the size of the set of K1s being limited by the 3GPP standards.

The SpCell may monitor network node inter-link delay changes through traffic related information exchanges between the SpCell and the SCell and may monitor delay reports from upper layers and re-evaluate the current delay range profile. The current measured delay: d=t_rx−t_tx, where t_rx is the time stamp at which the message is received from the SCell, and t_tx is the time stamp indicated by the SCell in the packet header.

If the delay range has been changed, the current K1 set may not give optimal transmission performance and another set of K1s (and/or another K1) may be determined for reconfiguration of the impacted WDs 22.

### Embodiment 2: Online Learning for K1 Value Subset Selection

In some embodiments, the SCell may determine the smallest K1 value in the set that is larger than the maximum delay plus a safety margin. The SCell may build a subset of the configured K1s with the above minimal K1 as the smallest K1 value and/or use them as offsets between a physical downlink shared channel (PDSCH) transmission and HARQ-ACK feedbacks. During run time traffic, the SpCell may measure transport delays of the messages coming from the SCell, for informing DL data scheduling result. The current measured delay: d=t_rx−t_tx, where t_rx is the time stamp at which the message is received from the SpCell, and t_tx is the time stamp indicated by the SpCell in the packet header.

The SpCell may send the measured delay to the SCell along with the WD HARQ-ACK feedbacks for the SCell DL transmissions. The SCell may also measure the inter-network node link delay, e.g., along the ones received from the SpCell such as to reevaluate if the current K1 subset is the optimal one, as follows:
The SCell may determine the smallest K1 value in the set that is larger than the maximum delay plus a safety margin; and/or
A new subset of node K1s may also be built with the new minimal K1 as the smallest value.

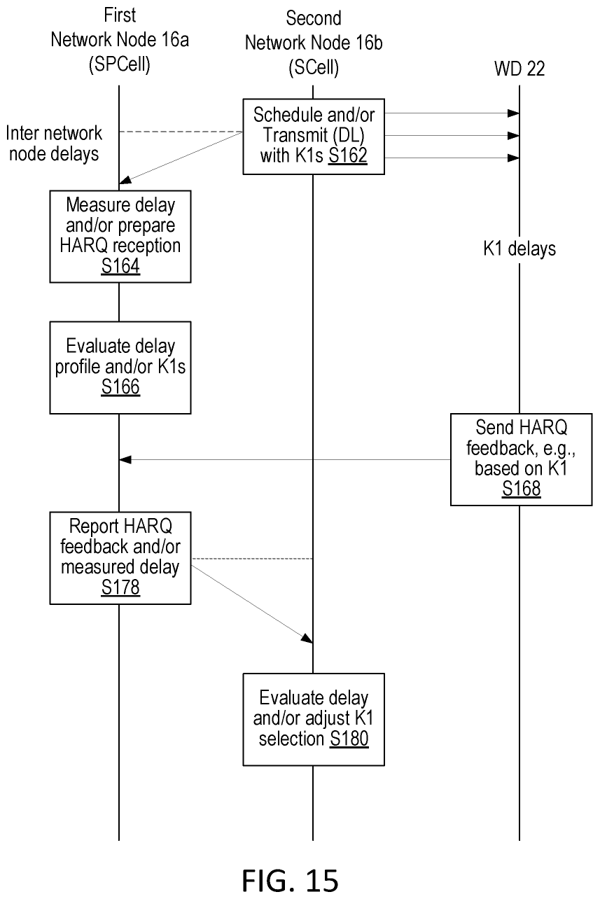

A signal diagram of the above-described Embodiments 1 and 2 is shown in FIG. 15. A first network node 16a (e.g., being and/or operating an SpCell), a second network node 16b (e.g., being and/or operating an SCell), and a WD 22 (operating in any of cell associated with the first and/or second network nodes such as an SpCell and SCell, respectively). At step S162, the second network node 16b schedules and/or transmits, e.g., via downlink, a signal including at least one K1. At step S164, the first network node 16a measures and/or prepares HARQ reception. At step S166, the first network node 16a evaluates delay profile and/or at least one K1. At step S168, WD 22 transmits HARQ feedback, e.g., based on at least one K1, to the first network node 16a. At step S178, the first network node 16a reports (i.e., transmits, sends, etc.) HARQ feedback and/or measured delay to the second network node 16b. At step S180, the second network node evaluates/determines delay and/or adjusts K1 selection.

Some embodiments enable carrier aggregation between non-collocated cells while guaranteeing robust feedback from the WD 22. Some embodiments provide dynamic optimization of selected configurations to strike a balance between robustness to inter-network node link delay and end-user delay.

According to one aspect, a first network node 16a operating on a first cell configured to communicate with a wireless device (WD) is provided. The first network node 16a includes a radio interface 62 and/or processing circuitry 68 configured to: determine a link profile of a link between the first network node 16a and a second network node 16b operating on a second cell. The first network node 16a, radio interface 62 and/or processing circuitry 68 are further configured to determine a set of K1 values, each K1 value indicating a delay between a downlink transmission and a corresponding hybrid automatic repeat request (HARQ) feedback on the second cell, the set of K1 values being determined based at least in part on the link profile.

According to this aspect, in some embodiments, the set of K1 values is determined based at least in part on at least one of delay, jitter and packet loss. In some embodiments, the first network node 16a and the second network node 16b are collocated. In some embodiments, the first network node 16a, radio interface 62 and/or the processing circuitry 68 is further configured to monitor the link and update the link profile. In some embodiments, the set of K1 values includes at least one K1 value that is greater than a maximum delay plus a safety margin. In some embodiments, the set of K1 values has a smallest K1 value in the set that is greater than a minimal delay plus a safety margin.

According to another aspect, a method implemented in a first network node 16a operating on a first cell is provided. The method includes determining a link profile of a link between the first network node 16a and a second network node 16b operating on a second cell; and determining a set of K1 values, each K1 value indicating a delay between a downlink transmission and a corresponding hybrid automatic repeat request (HARQ) feedback on the second cell, the set of K1 values being determined based at least in part on the link profile.

According to this aspect, in some embodiments, the set of K1 values is determined based at least in part on at least one of delay, jitter and packet loss. In some embodiments, the first network node 16a and the second network node 16b are collocated. In some embodiments, the method further includes monitoring the link and updating the link profile. In some embodiments, the set of K1 values includes at least one K1 value that is greater than a maximum delay plus a safety margin. In some embodiments, the set of K1 values has a smallest K1 value in the set that is greater than a minimal delay plus a safety margin.

According to yet another aspect, a first network node 16a operating on a first cell configured to communicate with a wireless device (WD) 22 is provided. The first network node 16a includes a radio interface 62 and/or processing circuitry 68 configured to: receive from a second network node 16b operating on a second cell, a set of K1 values, each K1 value indicating a delay between a downlink transmission and a corresponding hybrid automatic repeat request (HARQ) feedback message on the first cell. The first network node 16a, radio interface 68 and/or processing circuitry is further configured to determine a subset of the set of K1 values, the subset having a smallest K1 value in the set that is greater than a minimal delay plus a safety margin and having K1 values above the smallest K1 value.

According to this aspect, in some embodiments, the first network node 16a, radio interface and/or processing circuitry is further configured to measure a link delay of a link between the first network node 16a and the second network node 16b. In some embodiments, the first network node 16a, radio interface 62 and/or processing circuitry 68 is further configured to receive from the second network node 16b, a link delay of a link between the first network node 16a and the second network node 16b.

According to another aspect, a method is implemented in a first network node 16a operating on a first cell. The method includes receiving from a second network node 16b operating on a second cell, a set of K1 values, each K1 value indicating a delay between a downlink transmission and a corresponding hybrid automatic repeat request (HARQ) feedback message on the first cell. The method further includes determining a subset of the set of K1 values, the subset having a smallest K1 value in the set that is greater than a minimal delay plus a safety margin and having K1 values above the smallest K1 value.

According to this aspect, in some embodiments, the first network node 16a, radio interface 62 and/or processing circuitry 68 is further configured to measure a link delay of a link between the first network node 16a and the second network node 16b. In some embodiments, the first network node 16a, radio interface 62 and/or processing circuitry 68 is further configured to receive from the second network node 16b, a link delay of a link between the first network node 16a and the second network node 16b.

Further, the following is a nonlimiting list of some embodiments according to the principles of the present disclosure:

Embodiment A1. A first network node operating on a first cell configured to communicate with a wireless device (WD), the first network node configured to, and/or comprising a radio interface and/or comprising processing circuitry configured to:
determine a link profile of a link between the first network node and a second network node operating on a second cell; and
determine a set of K1 values, each K1 value indicating a delay between a downlink transmission and a corresponding hybrid automatic repeat request (HARQ) feedback on the second cell, the set of K1 values being determined based at least in part on the link profile.

Embodiment A2. The first network node of Embodiment A1, wherein the set of K1 values is determined based at least in part on at least one of delay, jitter and packet loss.

Embodiment A3. The first network node of any of Embodiments A1 and A2, wherein the first network node and the second network node are collocated.

Embodiment A4. The first network node of any of Embodiments A1-A3, wherein the first network node, radio interface and/or the processing circuitry is further configured to monitor the link and update the link profile.

Embodiment A5. The first network node of any of Embodiments A1-A4, wherein the set of K1 values includes at least one K1 value that is greater than a maximum delay plus a safety margin.

Embodiment A6. The first network node of any of Embodiments A1-A5, wherein the set of K1 values has a smallest K1 value in the set that is greater than a minimal delay plus a safety margin.

Embodiment B1. A method implemented in a first network node operating on a first cell, the method comprising:
determining a link profile of a link between the first network node and a second network node operating on a second cell; and
determining a set of K1 values, each K1 value indicating a delay between a downlink transmission and a corresponding hybrid automatic repeat request (HARQ) feedback on the second cell, the set of K1 values being determined based at least in part on the link profile.

Embodiment B2. The method of Embodiment B1, wherein the set of K1 values is determined based at least in part on at least one of delay, jitter and packet loss.

Embodiment B3. The method of any of Embodiments B1 and B2, wherein the first network node and the second network node are collocated.

Embodiment B4. The method of any of Embodiments B1-B3, further comprising monitoring the link and updating the link profile.

Embodiment B5. The method of any of Embodiments B1-B4, wherein the set of K1 values includes at least one K1 value that is greater than a maximum delay plus a safety margin.

Embodiment B6. The method of any of Embodiments B1-B5, wherein the set of K1 values has a smallest K1 value in the set that is greater than a minimal delay plus a safety margin.

Embodiment C1. A first network node operating on a first cell configured to communicate with a wireless device (WD), the first network node configured to, and/or comprising a radio interface and/or comprising processing circuitry configured to:
receive from a second network node operating on a second cell, a set of K1 values, each K1 value indicating a delay between a downlink transmission and a corresponding hybrid automatic repeat request (HARQ) feedback message on the first cell; and
determine a subset of the set of K1 values, the subset having a smallest K1 value in the set that is greater than a minimal delay plus a safety margin and having K1 values above the smallest K1 value.

Embodiment C2. The first network node of Embodiment C1, wherein the first network node, radio interface and/or processing circuitry is further configured to measure a link delay of a link between the first network node and the second network node.

Embodiment C3. The first network node of Embodiment C1, wherein the first network node, radio interface and/or processing circuitry is further configured to receive from the second network node, a link delay of a link between the first network node and the second network node.

Embodiment D1. A method implemented in a first network node operating on a first cell, the method comprising:
receiving from a second network node operating on a second cell, a set of K1 values, each K1 value indicating a delay between a downlink transmission and a corresponding hybrid automatic repeat request (HARQ) feedback message on the first cell; and
determining a subset of the set of K1 values, the subset having a smallest K1 value in the set that is greater than a minimal delay plus a safety margin and having K1 values above the smallest K1 value.

Embodiment D2. The method of Embodiment D1, wherein the first network node, radio interface and/or processing circuitry is further configured to measure a link delay of a link between the first network node and the second network node.

Embodiment D3. The method of Embodiment D1, wherein the first network node, radio interface and/or processing circuitry is further configured to receive from the second network node, a link delay of a link between the first network node and the second network node.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A first network node configured to communicate with a second network node and a wireless device, WD, the first network node comprising:
processing circuitry configured to:
determine a link profile of a communication link between the first network node and the second network node; and
determine a set of time offset values, each time offset value indicating a time delay between a downlink transmission from the second network node and a corresponding uplink transmission from the WD to the first network node, the set of time offset values being determined based at least in part on the link profile; and
at least one of a communication interface and a radio interface configured to:
transmit the set of time offset values to the second network node;
receive the corresponding uplink transmission from the WD; and
transmit a report to the second network node, the report including at least the received corresponding uplink transmission from the WD.

2. The first network node of claim 1, wherein each time offset value of the set of time offset values is a K1 value indicating the time delay between the downlink transmission and the corresponding uplink transmission.

3. The first network node of claim 1, wherein the corresponding uplink transmission is a Hybrid Automatic Repeat Request, HARQ, feedback.

4. The first network node of claim 1, wherein the first network node operates on a first cell, the second network node operates on a second cell, and the WD operates on the first and second cells.

5. (canceled)

6. (canceled)

7. The first network node of claim 1, wherein the set of time offset values includes at least one time offset value that is greater than a maximum delay plus a safety margin.

8. The first network node of claim 1, wherein the set of time offset values includes a smallest time offset value in the set that is greater than a minimal delay plus a safety margin.

9. (canceled)

10. (canceled)

11. A method implemented in a first network node configured to communicate with a second network node and a wireless device, WD, the method comprising:
determining a link profile of a communication link between the first network node and the second network node; and
determining a set of time offset values, each time offset value indicating a time delay between a downlink transmission from the second network node and a corresponding uplink transmission from the WD to the first network node, the set of time offset values being determined based at least in part on the link profile;
transmitting the set of time offset values to the second network node;
receiving the corresponding uplink transmission from the WD; and
transmitting a report to the second network node, the report including at least the received corresponding uplink transmission from the WD.

12. The method of claim 11, wherein each time offset value of the set of time offset values is a K1 value indicating the time delay between the downlink transmission and the corresponding uplink transmission.

13. The method of claim 11, wherein the corresponding uplink transmission is a Hybrid Automatic Repeat Request, HARQ, feedback.

14. The method of claim 11, wherein the first network node operates on a first cell, the second network node operates on a second cell, and the WD operates on the first and second cells.

15. (canceled)

16. (canceled)

17. The method of claim 11, wherein the set of time offset values includes at least one time offset value that is greater than a maximum delay plus a safety margin.

18. The method of claim 11, wherein the set of time offset values includes a smallest time offset value in the set that is greater than a minimal delay plus a safety margin.

19. (canceled)

20. (canceled)

21. A second network node configured to communicate with a first network node and a wireless device, WD, the second network node comprising:
processing circuitry configured to:
determine a subset of a set of time offset values, each time offset value of the set of time offset values indicating a time delay between a downlink transmission from the second network node and a corresponding uplink transmission from the WD to the first network node, the set of time offset values being determined based at least in part on a link profile of a communication link between the first network node and the second network node, the determined subset including a smallest time offset value in the set that is greater than a maximum delay plus a safety margin and including time offset values above the smallest time offset value; and
at least one of a communication interface and a radio interface configured to:
receive from the first network node the set of time offset values to the second network node;
transmit to the WD any one of the determined subset of the set of time offset values and the downlink transmission; and
receive a report from the first network node, the report including at least the corresponding uplink transmission from the WD.

22. The second network node of claim 21, wherein each time offset value of the set of time offset values is a K1 value indicating the time delay between the downlink transmission and the corresponding uplink transmission.

23. The second network node of claim 21, wherein the corresponding uplink transmission is a Hybrid Automatic Repeat Request, HARQ, feedback.

24. The second network node of claim 21, wherein in the first network node operates on a first cell, the second network node operates on a second cell, and the WD operates on the first and second cells.

25. The second network node of claim 21, wherein the link profile includes a link time delay, a jitter, a packet loss, and a Round Trip Time, RTT, of a packet associated with the communication link between the first network node and the second network node.

26-28. (canceled)

29. The second network node of claim 21, wherein the processing circuitry is further configured to:
determine another link time delay of the communication link between the first network node and the second network node, determining the subset of the set of time offset values being further based on the other link time delay.

30. (canceled)

31. A method implemented in a second network node configured to communicate with a first network node and a wireless device, WD, the method comprising:
determining a subset of a set of time offset values, each time offset value of the set of time offset values indicating a time delay between a downlink transmission from the second network node and a corresponding uplink transmission from the WD to the first network node, the set of time offset values being determined based at least in part on a link profile of a communication link between the first network node and the second network node, the determined subset including a smallest time offset value in the set that is greater than a maximum delay plus a safety margin and including time offset values above the smallest time offset value;
receiving from the first network node the set of time offset values to the second network node;
transmitting to the WD any one of the determined subset of the set of time offset values and the downlink transmission; and
receiving a report from the first network node, the report including at least the corresponding uplink transmission from the WD.

32. The method of claim 31, wherein each time offset value of the set of time offset values is a K1 value indicating the time delay between the downlink transmission and the corresponding uplink transmission.

33. The method of claim 31, wherein the corresponding uplink transmission is a Hybrid Automatic Repeat Request, HARQ, feedback.

34. The method of claim 31, wherein in the first network node operates on a first cell, the second network node operates on a second cell, and the WD operates on the first and second cells.

35. The method of claim 31, wherein the link profile includes a link time delay, a jitter, a packet loss, and a Round Trip Time, RTT, of a packet associated with the communication link between the first network node and the second network node.

36-38. (canceled)

39. The method of claim 31, wherein the method further includes:
determining another link time delay of the communication link between the first network node and the second network node, determining the subset of the set of time offset values being further based on the other link time delay.

40-60. (canceled)
